(19) United States
(12) Patent Application Publication
(10) Pub. No.: US 2025/0120397 A1
(43) Pub. Date: Apr. 17, 2025

(54) PEST CONTROL METHOD

(71) Applicant: National Chung Hsing University, Taichung City (TW)

(72) Inventors: Menghsiao Meng, Taichung City (TW); ChengYu Chen, Wujie Township (TW); Sheng Huang, Tainan City (TW); Wei-Ming Leu, Taichung City (TW); Cheng-Cheng Lee, Taichung City (TW); Pei-Yi DAI, Taichung City (TW); YU CHEN HUANG, Yuanlin City (TW)

(21) Appl. No.: 18/511,201

(22) Filed: Nov. 16, 2023

(30) Foreign Application Priority Data
Oct. 17, 2023 (TW) 112139553

(51) Int. Cl. A01N 27/00; A01N 25/18; A01P 7/04

(52) U.S. Cl. CPC A01N 27/00; A01N 25/18; A01P 7/04

(57) ABSTRACT

A pest control method includes providing a pest control composition or a vapor thereof in a space to kill at least one kind of pests in the space by toxicity. The pest control composition at least includes an active ingredient in an effective amount, and the active ingredient is an alkane with 10, 12, 14, or 16 carbon atoms or an isomer thereof.

### BACKGROUND OF THE INVENTION

### 1. Technical Field

The present invention relates to a pest control method. More particularly, the invention relates to the use of a hydrocarbon or an isomer thereof as a pest control composition and a pest control method using the pest control composition.

### 2. Description of Related Art

Some examples of pest control compositions that have been approved for use are hydrogen phosphide, methyl bromide, and sulfuryl fluoride. These compositions are highly effective in pest control but are either toxic to humans and animals or destructive to the environment. For example, methyl bromide is destructive to the ozone layer despite its desirable pest-killing properties, and because of that, the Montreal Protocol stipulates that methyl bromide should be used only at customs for quarantine purposes and should be phased out on a yearly basis. Hydrogen phosphide is a substitute for methyl bromide, is highly pesticidal but also extremely toxic to humans and animals, and therefore must be used in accordance with relevant operation standards. Sulfuryl fluoride is effective in controlling termites and other pests in buildings, but research results have shown that it is about 4800 times as capable of producing the greenhouse effect as carbon dioxide and may accelerate global warming.

The existing pest control compositions are detrimental to environmental sustainability and/or the health of humans and animals, and yet the demand for pest control persists. The global pest control market is in need of a novel pest control composition that is highly safe to humans and animals and eco-friendly.

### BRIEF SUMMARY OF THE INVENTION

The primary objective of the present invention is to provide a pest control method that uses a pest control composition whose active ingredient is non-toxic, safe, and eco-friendly. The aforesaid properties of the active ingredient make the pest control composition an ideal substitute for the conventional pesticides or environmental agents so that friendliness to the environment and animals can be achieved.

Another objective of the present invention is to provide a pest control method in which the pest control composition can kill pests by toxicity through direct or indirect contact with the pests and therefore can be extensively used in various environmental agents or agricultural chemicals.

To attain the foregoing objectives, the present invention discloses a pest control method that includes providing a pest control composition or a vapor thereof in a space to kill at least one kind of pests in the space by toxicity. The pest control composition has an active ingredient, and the active ingredient is an alkane with 10, 12, 14, or 16 carbon atoms or is an isomer thereof.

The pest control composition disclosed in the present invention can kill many kinds of pests by toxicity, including Sitophilus oryzae (rice weevil), Tetranychus urticae (two-spotted spider mite), Lasioderma serricorne (cigarette beetle), Blattella germanica (German cockroach), Anoplolepis longipes (long-legged ant), Solenopsis invicta (red imported fire ant), and mosquito larvae. Therefore, the pest control method disclosed in the present invention and the pest control composition used therein can be applied to the control of pests harmful to crops and the control of other pests in the environment.

In one embodiment of the present invention, the active ingredient may be n-decane, n-dodecane, n-tetradecane, n-hexadecane, or an isomer corresponding to any of the aforesaid compounds, such as an isodecane, an isododecane, an isotetradecane, or an isohexadecane.

An isodecane is an isomer of n-decane and, depending on the positions of its functional groups, may have different structural formulae, one example of which is 2-methylnonane.

An isododecane is an isomer of n-dodecane and, depending on the positions of its functional groups, may have different structural formulae, some examples of which are 2,2,4,6,6-pentamethylheptane and 2-methylundecane.

An isotetradecane is an isomer of n-tetradecane and, depending on the positions of its functional groups, may have different structural formulae, one example of which is 2-methyltridecane.

An isohexadecane is an isomer of n-hexadecane and, depending on the positions of its functional groups, may have different structural formulae, one example of which is 2,2,4,4,6,8,8-heptamethylnonane.

In one embodiment of the present invention, the pest control composition is in the dosage form of a fumigant, a spray, or a solution. When the pest control composition is in the dosage form of a fumigant, the pest control composition is used in such an amount that the dosage of the hydrocarbon and/or the isomer thereof is not less than 5 mg for each liter of the volume of the space to be fumigated. A preferred pesticidal effect can be achieved when the dosage of the hydrocarbon and/or the isomer thereof is not less than 30 mg per liter of the volume of the space to be fumigated.

Another embodiment of the present invention discloses a pest control method that includes providing an effective amount of a pest control composition or of a vapor thereof in a space, wherein the pest control composition has an active ingredient composed of an effective amount of the foregoing hydrocarbon and/or the isomer thereof, wherein the effective amount of the hydrocarbon and/or the isomer thereof is at least 2.5 mg, preferably at least 5 mg, per liter of the volume of the space.

### BRIEF DESCRIPTION OF THE SEVERAL VIEWS OF THE DRAWINGS

None

### DETAILED DESCRIPTION OF THE INVENTION

The present invention discloses a pest control method. The pest control method includes providing a pest control composition or a vapor thereof in a space to kill at least one kind of pests in the space by toxicity. The pest control composition comprises an effective amount of an active ingredient, and the active ingredient is an alkane with 10 to 16 carbon atoms or an isomer thereof; is non-toxic to humans, animals, or the environment; and has pesticidal activity.

In one embodiment of the present invention, the space may be an open area or a closed area. A preferred pesticidal effect can be achieved when the space is a closed area.

In one embodiment of the present invention, the active ingredient is volatile and therefore can cause a loss of activity, or death, of pests by direct or indirect contact with the pests or their bodies. For example, the active ingredient may have the activity to kill at least one kind of pests by toxicity when in the form of a vapor, and in that case, it is feasible to put the pest control composition in a space and allow the active ingredient to evaporate and thereby turn into a vapor in the space so that pests will die because of inhalation of the active ingredient in the vapor form.

In one embodiment of the present invention, the active ingredient is n-decane, n-dodecane, n-tetradecane, or n-hexadecane.

In one embodiment of the present invention, the active ingredient is an isoparaffin such as an isodecane, an isododecane, or an isotetradecane.

The pest control composition disclosed in the present invention may be prepared in different dosage forms (e.g., a fumigant, a spray, a liquid, and a volatile solid), depending on such factors as user needs, the area where the composition will be used, and the target(s) against which the composition will be used. The effective amount of the active ingredient in the pest control composition will vary with the dosage form, but changes in the effective amount, either in terms of dosage or concentration, do not constitute a departure from the scope of the present invention as defined by the appended claims. In addition, the pest control composition may include an agriculturally acceptable ingredient such as a spreading agent or a solvent in order to be prepared in different dosage forms.

For example, when the pest control composition is a fumigant, the effective amount of the active ingredient is not less than 5 mg (e.g., is 5 mg, 10 mg, 15 mg, 20 mg, or 30 mg) per liter of the volume of the space where the pest control composition is provided.

When the pest control composition is a spray or a liquid instead, the effective amount of the active ingredient is at least 2.5 mg per liter of the volume of the space where the pest control composition is provided.

The term “alkane,” also known as paraffin, refers to a hydrocarbon whose entire structure is composed mainly of carbon and hydrogen atoms, and in which the carbon-carbon bonds and carbon-hydrogen bonds are single bonds.

The term “n-decane,” also known as normal decane or decane, refers to a hydrocarbon having the molecular formula C₁₀H₂₂ and the following structural formula (I). n-decane is a nonpolar molecule and one of the constituents of gasoline.

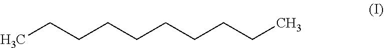

The term “n-dodecane,” also known as dodecane or bihexyl, refers to a hydrocarbon having the molecular formula C₁₂H₂₆ and the following structural formula (II). n-dodecane is a thick, sticky, colorless, and odorless oil-like liquid.

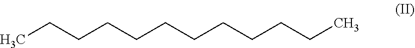

The term “n-tetradecane,” also known as tetradecane, refers to a hydrocarbon having the molecular formula C₁₄H₃₀ and the following structural formula (III). n-tetradecane is a nonpolar molecule insoluble in water and exists in petroleum.

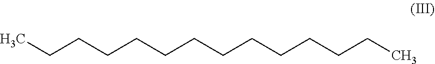

The term “n-hexadecane,” also known as hexadecane, refers to a hydrocarbon having the molecular formula C₁₆H₃₄ and the following structural formula (IV). n-hexadecane may exist as a white solid or a colorless liquid, is soluble in an ether or petroleum ether, but is insoluble in water.

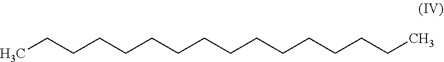 [SMILES: CCCCCCCCCCCCCCCC]

The term “isomer” refers to one of two or more molecules that have the same molecular formula, the same functional groups, but different structural formulae. Isomers of different structures have similar or identical properties.

The term “isodecane” refers to an isomer of n-decane. The following structural formula (V) represents 2-methylnonane, which is an isodecane.

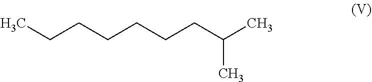

The term “isododecane” refers to an isomer of n-dodecane. For example, the following structural formulae (VI), (VII), and (VIII) represent 2,2,4,6,6-pentamethylheptane, 2-methylundecane, and 3-methylundecane, respectively, all of which are isododecanes.

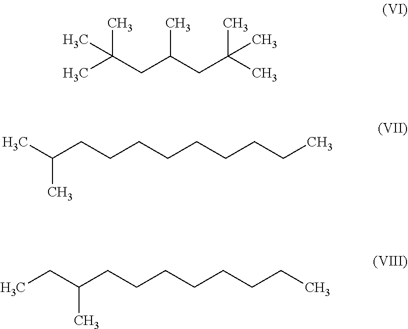

The term “isotetradecane” refers to an isomer of n-tetradecane. For example, the following structural formula (IX) represents 2-methyltridecane, which is an isotetradecane.

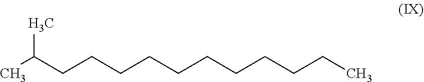

The term “isohexadecane” refers to an isomer of n-hexadecane. For example, the following structural formula (X) represents 2,2,4,4,6,8,8-heptamethylnonane, which is an isohexadecane.

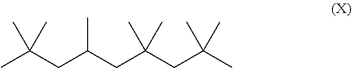 [SMILES: CC(CC(C)(C)C)CC(C)(C)CC(C)(C)C]

The term “pest” refers to an organism that has a negative effect on humans and human activities, e.g., that is harmful to crops, animals, or trees, or that may transmit a disease and thus jeopardize human health. Pests include insects and non-insects. Some examples of pests are Sitophilus oryzae (rice weevil), Tetranychus urticae (two-spotted spider mite), Lasioderma serricorne (cigarette beetle), Blattella germanica (German cockroach), Anoplolepis longipes (long-legged ant), Solenopsis invicta (red imported fire ant), and mosquito larvae.

The term “space” refers to a place where the pest control composition disclosed in the present invention and/or the active ingredient thereof is applied. The space may be formed by or located in a natural environment (e.g., an ant nest), be constructed by humans (e.g., a closed space formed by a tent or a closed greenhouse), or have a specific use but no clearly defined border (e.g., a sports field or farmland).

The term “fumigant” refers to a composition whose active ingredient can evaporate and thus become a vapor or gas so as to kill pests by toxicity. The dosage of a fumigant depends on such factors as the pesticidal effect of the active ingredient, the kind(s) of the pests to be killed, and the size of the place to be fumigated. The main active ingredient of a fumigant based on the present invention is an alkane with 10, 12, 14, or 16 carbon atoms or an isomer thereof.

The term “spray” refers to a vaporous dosage form into which a liquid is rendered by high pressure or compressed air. When the pest control composition disclosed in the present invention is a spray, the active ingredient can contact the bodies of pests either actively or passively. The term “actively” means the vaporous composition is sprayed directly on the bodies of pests, whereas the term “passively” means the vaporous composition is sprayed on a wall of the space or an object in the space such that pests contact the vaporous composition by staying on or crawling over the sprayed wall or object.

The term “spreading agent,” also known as a surfactant, refers to a chemical that is both hydrophilic and lipophilic and can assist in emulsifying, dispersing, fixating, and spreading the active ingredient of the pest control composition disclosed in the present invention.

The term “spreading agent for agricultural use” refers to a spreading agent that is agriculturally acceptable.

The term “agriculturally acceptable ingredient” refers to an ingredient (e.g., a surfactant or organic solvent) that, according to any domestic or foreign regulation or common general knowledge, can be used in or as an agricultural chemical or environmental agent.

The term “effective amount” refers to a dosage or concentration that is sufficient to effectively kill pests in a space by toxicity. The effective amount varies with, among others, the dosage form, the area where the pest control composition disclosed in the present invention is used, and the target(s) against which the pest control composition is used.

To better demonstrate the technical features and effects of the present invention, a detailed description of some examples is given below.

All the compounds used in the following examples are commercially available.

### Example 1: Pest Killing Experiment (1)

Sitophilus oryzae (rice weevil), Tetranychus urticae (two-spotted spider mite), Lasioderma serricorne (cigarette beetle), Blattella germanica (German cockroach), Anoplolepis longipes (long-legged ant), and Solenopsis invicta (red imported fire ant) were used as the test objects of this experiment and were each put into several 1-L containers. A carrier containing an isododecane (or 2,2,4,6,6-pentamethylheptane to be exact) at each of a plurality of predetermined concentrations (i.e., 2.5, 5, 10, 20, 30, and 40 mg) was then put into one of the 1-L containers of each test object, before the containers were sealed to start a 24-hour fumigation process. After that, the containers were aerated, and the numbers of deaths of each kind of pests were counted. The fatality rates were subsequently calculated, and the results are shown in Table 1.

TABLE 1
Fatality rates of different kinds of pests in association
with an isododecane at different concentrations

| | Fatality rate (%) | | | | | |
|---|---|---|---|---|---|---|
| | Lasioderma | Sitophilus | Tetranychus | Blattella | Anoplolepis | Solenopsis |
| Dose | serricorne | oryzae | urticae | germanica | longipes | invicta |
| Control | 0 | 0 | 0 | 0 | 0 | 0 |
| (0 mg) | | | | | | |
| 2.5 mg | 5 | 0 | 45 | 7 | 8 | 32 |
| 5 mg | 18 | 7 | 72 | 18 | 14 | 55 |
| 10 mg | 25 | 22 | 100 | 38 | 32 | 100 |
| 20 mg | 42.11 | 30 | 100 | 88.89 | 80 | 100 |
| 30 mg | 100 | 100 | 100 | 100 | 100 | 100 |
| 40 mg | 100 | 100 | 100 | 100 | 100 | 100 |

The results in Table 1 show that fumigation with the isododecane at a concentration of 5 mg or higher was effective in killing all the pests by toxicity and was particularly effective in killing Tetranychus urticae by toxicity. When the concentration of the isododecane was 30 mg or higher, the rate at which each kind of pests was killed by toxicity reached 100%.

### Example 2: Pest Killing Experiment (2)

Sitophilus oryzae, Tetranychus urticae, Lasioderma serricorne, Blattella germanica, Anoplolepis longipes, and Solenopsis invicta were each put into several 1-L containers. A carrier containing each of n-dodecane, n-decane, 2-methylnonane (an isodecane), and 2,2,4,6,6-pentamethylheptane (an isododecane) at a concentration of 30 mg was then put into one of the 1-L containers of each test object, before the containers were sealed to start a 24-hour fumigation process. After that, the containers were aerated, and the numbers of deaths of each kind of pests were counted. The fatality rates were subsequently calculated, and the results are shown in Table 2.

TABLE 2
Fatality rates of different kinds of pests in association
with different compounds (at a concentration of 30 mg)

| | Fatality rate (%) | | | | | |
|---|---|---|---|---|---|---|
| Compound | Solenopsis | Anoplolepis | Blattella | Tetranychus | Lasioderma | Sitophilus |
| (30 mg) | invicta | longipes | germanica | urticae | serricorne | oryzae |
| Control | 0 | 0 | 0 | 0 | 0 | 0 |
| (no compound) | | | | | | |
| n-dodecane | 5 | 25 | 22.22222 | 95 | 100 | 50 |
| n-decane | 100 | 75 | 100 | 100 | 100 | 100 |
| 2-methylnonane | 100 | 90 | 100 | 100 | 100 | 100 |
| 2,2,4,6,6- | 100 | 100 | 100 | 100 | 100 | 100 |
| pentamethylheptane | | | | | | |

The results in Table 2 show that n-decane, n-dodecane, and their isomers were significantly effective in killing each kind of pests by toxicity. In particular, the isododecane was the most effective in killing each kind of pests by toxicity.

### Example 3: Pest Killing Experiment (3)

Artificially raised non-pathogenic mosquito larvae were divided into a plurality of groups each including 30 larvae. Each group of larvae was put into a 1-L container together with 100 mL of deionized water. Then, a reagent containing a spreading agent for agricultural use as well as an isododecane and an isohexadecane in a ratio of 4:1 was added into the deionized water in each container at one of a plurality of predetermined doses and thoroughly mixed. The containers were left uncovered. After 24 hours, the numbers of deaths of the mosquito larvae were counted. The fatality rates were subsequently calculated, and the results are shown in Table 3.

TABLE 3
Fatality rates of mosquito larvae in association with
an isododecane and an isohexadecane at different doses

| | Fatality rate (%) | | | | | |
|---|---|---|---|---|---|---|
| Dose | 0 (control) | 2.5 mg | 5 mg | 10 mg | 20 mg | 40 mg |
| Isododecane | 0 | 33 | 50 | 80 | 100 | 100 |
| Isohexadecane | 0 | 45 | 60 | 100 | 100 | 100 |

The results in Table 3 show that the isododecane and the isohexadecane were effective in killing mosquito larvae by toxicity, and that the fatality rates of mosquito larvae exceeded 50% when the doses were 5 mg per 100 ml of water or higher.

What is claimed is:

1. A pest control method, comprising: providing a pest control composition or a vapor thereof in a space to kill at least one kind of pests in the space by toxicity, wherein the pest control composition comprises an effective amount of an active ingredient, and the active ingredient is an alkane with 10, 12, 14, or 16 carbon atoms or is an isomer thereof.

2. The pest control method of claim 1, wherein the active ingredient is n-decane, n-dodecane, n-tetradecane, n-hexadecane, or an isomer of any of the aforesaid compounds.

3. The pest control method of claim 1, wherein the at least one kind of pests comprises insects and non-insect organisms.

4. The pest control method of claim 3, wherein the at least one kind of pests is Sitophilus oryzae (rice weevil), Tetranychus urticae (two-spotted spider mite), Lasioderma serricorne (cigarette beetle), Blattella germanica (German cockroach), Anoplolepis longipes (long-legged ant), Solenopsis invicta (red imported fire ant), or mosquito larvae.

5. The pest control method of claim 1, wherein the pest control composition is in a dosage form of a fumigant, a spray, or a solution.

6. The pest control method of claim 5, wherein when the pest control composition is not a fumigant, the effective amount of the active ingredient is at least 2.5 mg per liter of the volume of the space.

7. The pest control method of claim 5, wherein when the pest control composition is a fumigant, the effective amount of the active ingredient is at least 5 mg per liter of the volume of the space.
